(19) United States
(12) Patent Application Publication
(10) Pub. No.: US 2013/0098171 A1
(43) Pub. Date: Apr. 25, 2013

(54) APPARATUS FOR SAMPLING CARBON PARTICLE

(71) Applicants: Hyoun Cher JIN, Seoul (KR); Saixiyaletu, Seoul (KR); Shang Gyoo SHIM, Seoul (KR); Jin Young KIM, Seoul (KR)

(72) Inventors: Hyoun Cher JIN, Seoul (KR); Saixiyaletu, Seoul (KR); Shang Gyoo SHIM, Seoul (KR); Jin Young KIM, Seoul (KR)

(73) Assignee: Korea Institute of Science and Technology, Seoul (KR)

(21) Appl. No.: 13/659,071

(22) Filed: Oct. 24, 2012

(30) Foreign Application Priority Data
Oct. 24, 2011 (KR) 10-2011-0108771

(51) Int. Cl. G01N 1/02

(52) U.S. Cl. 73/863.12; 73/863.73; 73/863.23; 73/863.11

(57) ABSTRACT

Disclosed is an apparatus for sampling carbon particles emitted, for example, from a charcoal kiln, including: a sampling tube introducing samples including carbon particles from a carbon particle emission source; a first manifold collecting the samples introduced from the sampling tube; a first suction means transferring the samples from the carbon particle emission source to the first manifold through the sampling tube; a discharge tube discharging the samples from the first manifold; a second manifold collecting the samples introduced from the discharge tube and supplying them to a carbon particle collection unit; a second suction means transferring the samples introduced to the first manifold to the second manifold through the discharge tube; the carbon particle collection unit receiving the samples from the second manifold and collecting the carbon particles included in the samples; and a third suction means transferring the samples introduced to the second manifold to the carbon particle collection unit.

### CROSS-REFERENCE TO RELATED APPLICATION

This application claims priority to Korean Patent Application No. 10-2011-108771, filed on Oct. 24, 2011, and all the benefits accruing therefrom under 35 U.S.C. §119, the contents of which in its entirety are herein incorporated by reference.

### BACKGROUND

1. Field

The present disclosure relates to an apparatus for sampling carbon particles emitted, for example, from a charcoal kiln. More specifically, the disclosure relates to an apparatus for sampling carbon particles capable of easily sampling carbon particles from a carbon particle emission source such as a charcoal kiln by inducing a stable sample flow.

2. Description of the Related Art

In general, particulate matter (PM) is divided into coarse particles (2.5<d≦10 μm, PM₁₀), fine particles (d≦2.5 μm, PM_{2.5}) and ultrafine particles (d≦0.1 μm) according to the particle diameter (d). Among them, PM_{2.5} is mainly produced during burning of fossil fuels, burning of plants (forest fire), smelting of metals, or the like. Since it can reach deep into the lungs, chemical components included therein can be easily absorbed into the human body. Especially, carbon particles are known to be very harmful to the human body.

Thus, carbon particles included in the particulate matter emitted from power plant or automobiles are subjected to compositional analysis and particle diameter measurement. For example, Korean Patent Publication No. 10-2011-0041512 discloses a particulate matter measurement device capable of continuously measuring the mass change of particulate matter included in exhaust gas.

For measurement or analysis of particulate matter, sampling (collection) of the particulate matter from an emission source should precede. In general, the particulate matter included in the exhaust gas is sampled (collected) after sampling an adequate amount of sample and transferring the sample to a particle collection unit. Mostly, the particulate matter is sampled (collected) by a filter installed on a sampling line or by a filter following separation by cyclone, gravitational sedimentation, inertial collision, or the like. For example, Korean Patent Registration No. 10-0576292 discloses a dust collection device using cyclone.

Formerly, charcoal-producing kilns were mostly distributed in the mountainous areas. But, recently, charcoal kilns in the urban areas are increasing for the purpose of charcoal production, spa, cooking, or the like. Accordingly, carbon particles produced during incomplete or complete combustion of fuels when producing charcoal cause soil and air pollution as well as offensive odor and human health problem.

However, lack of data about carbon particles makes it difficult for the government to make a national policy. Therefore, there is a need on development of an apparatus and a method for sampling carbon particles emitted, for example, from the charcoal kilns. In addition, since the pollutants emitted, for example, from the charcoal kilns include various particles with different sizes and properties, it is not easy to sample the carbon particles of specific size. A smooth and stable flow of carbon particle samples should be induced for effective sampling of carbon particles from a carbon particle emission source such as a charcoal kiln. However, since the existing particulate matter sampling technique lacks such a technical means, it is not easy to sample carbon particles of particular size, e.g. FM_{2.5}.

### REFERENCES OF THE RELATED ART

### Patent Documents

(Patent document 1) Korean Patent Publication No. 10-2011-0041512

(Patent document 2) Korean Patent Registration No. 10-0576292

### SUMMARY

The present disclosure is directed to providing an apparatus for sampling carbon particles capable of easily sampling carbon particles such as PM_{2.5} from a carbon particle emission source such as a charcoal kiln by inducing a smooth and stable flow of carbon particle samples.

In another aspect, there is provided an apparatus for sampling carbon particles including:

a sampling tube introducing samples including carbon particles from a carbon particle emission source;

a first manifold collecting the samples introduced from the sampling tube;

a first suction means transferring the samples from the carbon particle emission source to the first manifold through the sampling tube;

a discharge tube discharging the samples from the first manifold;

a second manifold collecting the samples introduced from the discharge tube and supplying them to a carbon particle collection unit;

a second suction means transferring the samples introduced to the first manifold to the second manifold through the discharge tube;

the carbon particle collection unit receiving the samples from the second manifold and collecting the carbon particles included in the samples; and

a third suction means transferring the samples introduced to the second manifold to the carbon particle collection unit.

The inner diameter of the first manifold may be larger than that of the sampling tube and the inner diameter of the second manifold may be larger than that of the discharge tube.

The carbon particle collection unit may include:

a separator separating the carbon particles from the introduced samples;

a filter unit collecting the carbon particles separated by the separator; and

a flow meter measuring the flow volume of the introduced samples.

The filter unit may include:

a first filter collecting carbon particles having a particle diameter exceeding 2.5 μm; and

a second filter collecting carbon particles having a particle diameter of 2.5 μm or smaller.

The apparatus for sampling carbon particles may further include a heat supply means preventing condensation of water. The heat supply means may be provided at at least one of the sampling tube, the first manifold, the discharge tube, the second manifold and the carbon particle collection unit.

In accordance with the present disclosure, carbon particles such as PM_{2.5} from a carbon particle emission source such as a charcoal kiln may be sampled easily since a smooth and stable flow of the carbon particle samples is induced. In addition, condensation of water owing to the temperature difference with the atmosphere may be prevented during transfer of the samples by the heat supply means.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIG. 1 shows a configuration of an apparatus for sampling carbon particles according to an exemplary embodiment of the present disclosure; and

FIG. 2 shows an important part of FIG. 1.

[Detailed Description of Main Elements]

| | |
|---|---|
| S: emission source | C: coupling unit |
| 110: sampling tube | 112: sample inlet port |
| 114: inlet tube | 120: first manifold |
| 130: discharge tube | 140: second manifold |
| 142: sample plenum | 144: dispensing tube |
| 200: particle collection unit | 210: separator |
| 212: incoming tube | 220: filter unit |
| 221: first filter | 222: second filter |
| 230: filter pack | 240: flow meter |
| 300: suction means | 400: heat supply means |
| 400C: heating controller | |

### DETAILED DESCRIPTION

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art.

An apparatus for sampling carbon particles (hereinafter, simply ‘sampling apparatus’) according to the present disclosure may be directly coupled to a carbon particle emission source S and easily sample carbon particles in the state where the introduced carbon particle samples are stabilized. Also, the apparatus may easily sample carbon particles of particular size, for example carbon particles with a particle diameter d of 2.5 μm or smaller (PM_{2.5}; d≦2.5 μm).

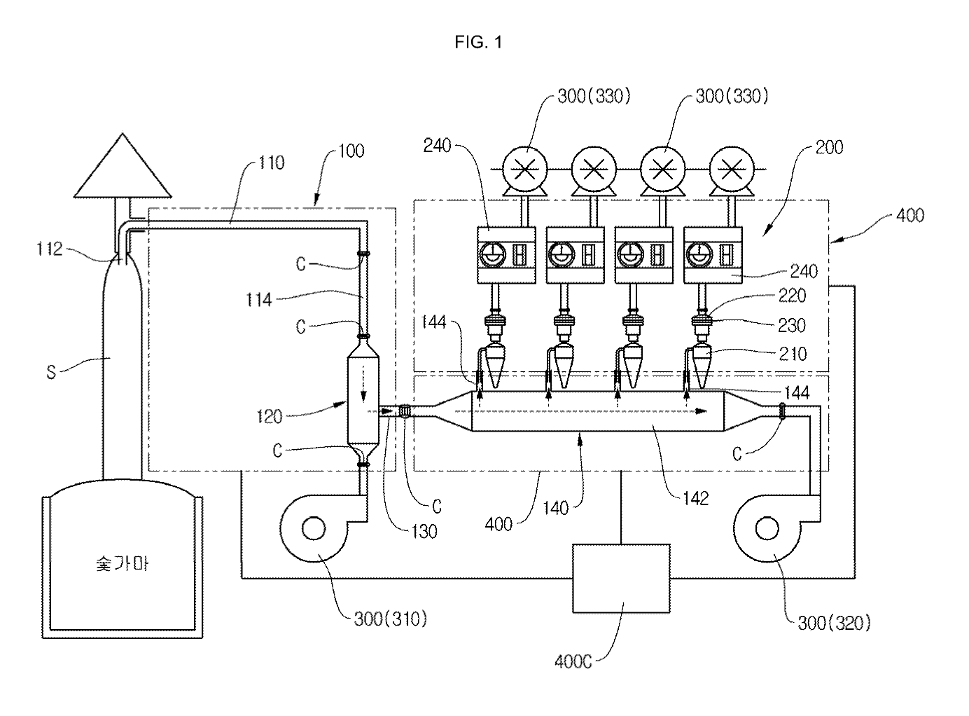

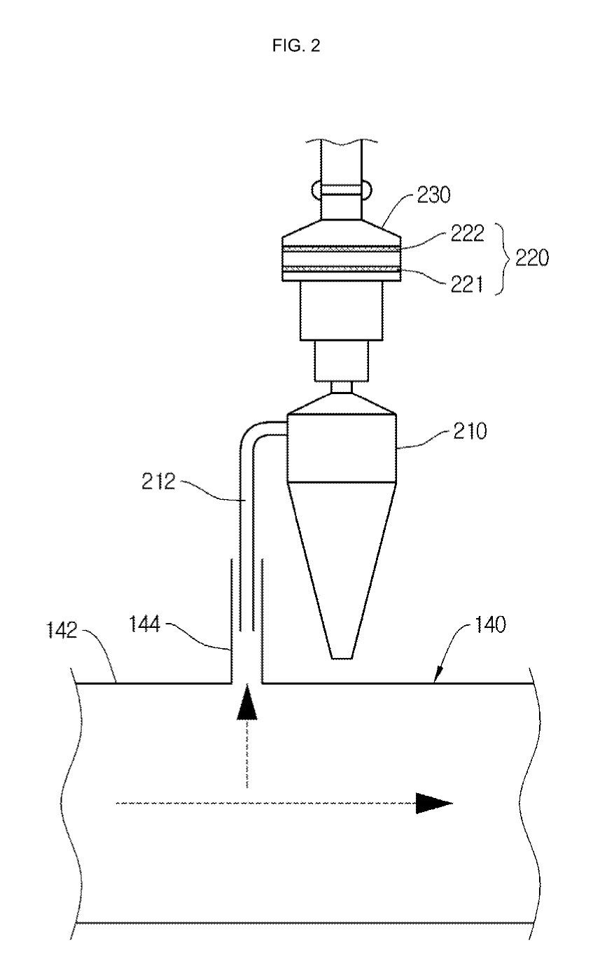

Referring to FIG. 1 and FIG. 2, a sampling apparatus according to the present disclosure comprises a sampling tube 110, a first manifold 120, a discharge tube 130, a second manifold 140, a carbon particle collection unit 200 and a suction means 300.

The sampling tube 110 introduces samples including carbon particles from a carbon particle emission source S. In the present disclosure, the carbon particle emission source S is not particularly limited as long as it emits substances including carbon particles. For example, it may be a (chimney) stack of a charcoal kiln or a boiler that emits a lot of carbon particles. FIG. 1 shows a stack of a charcoal kiln as an example of the carbon particle emission source S.

The first manifold 120 and the second manifold 140 stabilize the flow of the samples. The discharge tube 130 connects the first manifold 120 with the second manifold 140, and the carbon particle collection unit 200 collects the carbon particles included in the samples. And, the suction means 300 induces a smooth flow of the samples. The respective components will be described in detail.

The suction means 300 sucks the samples and transfers them to the respective components. Specifically, the suction means 300 comprises a first suction means 310 transferring the samples from the carbon particle emission source S to the first manifold 120 through the sampling tube 110, a second suction means 320 transferring the samples introduced to the first manifold 120 to the second manifold 140 through the discharge tube 130, and a third suction means 330 transferring the samples introduced to the second manifold 140 to the carbon particle collection unit 200. The suction force by the suction means 300: 310, 320, 330 forms a flow volume so as to ensure a smooth transfer of the samples. The suction means 300: 310, 320, 330 is not particularly limited as long as it transfers the samples by suction. For example, it may be selected from a blower, a suction pump (vacuum pump), or the like.

The sampling tube 110 is connected to the carbon particle emission source S. The sampling tube 110 introduces the samples from the carbon particle emission source S to the first manifold 120. In the present disclosure, the samples are substances emitted from the carbon particle emission source S and include at least the carbon particles and gaseous substances such as air. In addition, they may further include particulate matter other than the carbon particles.

The sampling tube 110 introduces the samples of adequate flow volume and may comprise a sample inlet port 112 disposed inside the carbon particle emission source S and an inlet tube 114 extending from the sample inlet port 112 and connected to the first manifold 120.

The first manifold 120 collects the samples introduced from the sampling tube 110 and ensures a stable flow. As shown in FIG. 1, the first manifold 120 has a larger inner diameter than that of the sampling tube 110. More specifically, the first manifold 120 may have a larger inner diameter than that of the inlet tube 114 of the sampling tube and may have, for example, a cylindrical shape. As seen in FIG. 1, the first manifold 120 may be disposed in a vertical direction. That is to say, it may be disposed in a vertical direction such that the introduced samples may flow vertically downward.

The samples introduced to the first manifold 120 have an adequate flow rate since they are forcibly sucked by the first suction means 310. The first manifold 120 stabilizes the flow of the samples by providing a space for decreasing the flow rate. That is to say, since the samples are introduced into the first manifold 120 having a larger inner diameter than that of the sampling tube 110, the flow rate is decreased and the flow is stabilized as a laminar flow is formed.

As shown in the figure, the sampling tube 110 may be connected to the upper end of the first manifold 120. And, the first suction means 310 may suck the samples at the lower end of the first manifold 120 so as to ensure the transfer of the samples. For a stable sample flow, the first manifold 120 may have an inner diameter, for example, 2 times or more, more specifically 2-20 times, larger than that that of the sampling tube 110, although not being specially limited thereto.

The discharge tube 130 communicates the first manifold 120 with the second manifold 140. The samples introduced to the first manifold 120 are supplied to the second manifold 140 along the discharge tube 130. One end of the discharge tube 130 is disposed inside the first manifold 120. Specifically, the discharge tube 130 may be disposed at the center portion of the first manifold 120, such that the samples may be discharged with a more stable flow (laminar flow) than the upper or lower portion.

The second manifold 140 collects the samples introduced from the discharge tube 130 and supplies the samples to the carbon particle collection unit 200 while ensuring a stable flow. As seen from the figure, the second manifold 140 has a larger inner diameter than that of the discharge tube 130.

The samples introduced to the second manifold 140 have an adequate flow rate as they are forcibly sucked by the second suction means 320. The second manifold 140 ensures a stable flow by providing a space for decreasing the flow rate. More specifically, the second manifold 140 comprises a sample plenum 142 collecting the samples introduced from the discharge tube 130. As seen from the figure, the sample plenum 142 may have a larger inner diameter than that of the discharge tube 130 and may have, for example, a cylindrical shape. As seen from the figure, the sample plenum 142 may be disposed in a horizontal direction. That is to say, it may be disposed in a horizontal direction such that the introduced samples may flow horizontally. The sample plenum 142 ensures a stable flow by providing a space wherein the samples are collected and decreasing the flow rate of the samples. That is to say, as the samples are introduced to the sample plenum 142 having a larger inner diameter than the discharge tube 130, the sample flow is stabilized as the flow rate decreases and a laminar flow is formed. For a stable sample flow, the sample plenum 142 may have an inner diameter, for example, 2 times or more, more specifically 2-20 times, larger than that of the discharge tube 130, although not being specially limited thereto.

In an exemplary embodiment, the second manifold 140 may comprise the sample plenum 142 and a plurality of dispensing tubes 144 formed on the sample plenum 142. The dispensing tubes 144 supply the samples collected by the sample plenum 142 to a plurality of particle collection units 200. The number of the dispensing tubes 144 may be the same as that of the particle collection units 200. That is to say, the sampling apparatus according to the present disclosure may comprise a plurality of particle collection units 200, and the number of the dispensing tubes 144 may be the same as that of the particle collection units 200. In the figure, 4 dispensing tubes 144 are shown.

The sampling tube 110, the first manifold 120, the discharge tube 130 and the second manifold 140 may comprise a metallic material or a glass material. Also, as described later, a heat supply means 400 may be provided at the individual components 110, 120, 130, 140 to prevent condensation of water. The individual components 110, 120, 130, 140 may also comprise a stainless steel material which is advantageous in terms of heat transfer. In an exemplary embodiment, the first manifold 120 may comprise a stainless steel material so as to improve heat transfer efficiency and the second manifold 140 may comprise a glass material. When the second manifold 140 comprises a glass material, it may have a suitable rigidity and allow observation of the flow of the carbon particles since the glass material is transparent.

The individual components 110, 120, 130, 140 may be connected with one another by a coupling unit C. Further, a valve (not shown) may be provided at the sampling apparatus according to the present disclosure. The valve may be provided, for example, between the sampling tube 110 and the first manifold 120, between the first manifold 120 and the first suction means 310, between the second manifold 140 and the second suction means 320, or the like. The valve may be configured to be opened and closed and control the flow volume of the samples.

The carbon particle collection unit 200 is not particularly limited as long as it can collect the carbon particles included in the samples. The samples are introduced from the second manifold 140 to the carbon particle collection unit 200 by the suction force of the third suction means 330 which may be, for example, a vacuum pump. The carbon particle collection unit 200 may comprise, for example, a filter unit 220 collecting the carbon particles. The filter unit 220 may comprise one or more filters 221, 222. More specifically, the particle collection unit 200 may comprise the filter unit 220 comprising one or more filters 221, 222 and a filter pack 230 enclosing the filter unit 220. The filter 221, 222 is not particularly limited as long as it can collect (sample) the carbon particles by filtering them. For example, it may be a quartz filter.

In an exemplary embodiment, the carbon particle collection unit 200 may comprise a separator 210 separating the carbon particles from the samples, the filter unit 220 collecting the carbon particles separated by the separator 210, and the filter pack 230 enclosing the filter unit 220. The separator 210 may be selected, for example, from a cyclone separator, a gravitational sedimentation separator and an inertial separator capable of separating the carbon particles from the samples. Specifically, the separator 210 may be a cyclone separator. In the figures, a cyclone separator is shown as an example of the separator 210. An incoming tube 212 introducing the samples may be provided at the separator 210. The incoming tube 212 may be communicated with the dispensing tube 144 of the second manifold 140.

The filter unit 220 may be configured as multi-stage filter unit comprising two or more filters 221, 222. In this case, the filter unit 220 may comprise a first filter 221 collecting carbon particles having a particle diameter exceeding 2.5 μm and a second filter 222 collecting carbon particles having a particle diameter of 2.5 μm or smaller.

The carbon particles included in the samples introduced from the second manifold 140 are separated as they are floated by the centrifugal force exerted by the separator 210, e.g. a cyclone separator. The separated carbon particles are collected (sampled) according to their size while passing through the multi-stage filter unit 220. Specifically, the carbon particles having a particle diameter exceeding 2.5 μm are collected by the first filter 221. And, the carbon particles having a particle diameter of 2.5 μm or smaller, i.e. PM_{2.5}, are collected and sampled by the second filter 222 after passing through the first filter 221. Accordingly, the carbon particles of a particular size, e.g. PM_{2.5}, may be sampled easily. Depending on the type of the filters 221, 222, carbon particles of desired size may be sampled.

The carbon particle collection unit 200 may further comprise a flow meter 240 measuring (and monitoring) the flow volume of the introduced samples. The flow meter 240 may be provided before the separator 210, between the separator 210 and the filter unit 220, or after the filter unit 220. In FIG. 1, the flow meter 240 is provided after the filter unit 220.

The sampling apparatus according to the present disclosure may comprise one or more of the carbon particle collection unit 200. In FIG. 1, four carbon particle collection units 200 each comprising one separator 210, one filter unit 220, one filter pack 230 and one flow meter 240 are shown.

As described above, the samples are introduced to the carbon particle collection unit 200 by the suction force of the third suction means 330. The third suction means 330 may also be provided in plural. That is to say, as shown in the figure, four suction means 330 may be provided corresponding to the number of the filter units 220.

The sampling apparatus according to the present disclosure may comprise the heat supply means 400 supplying heat. The samples emitted from the emission source S such as a charcoal kiln are at high temperature. As the samples are transferred to the individual components, condensation of water may occur owing to temperature difference with the atmosphere. The condensation of water may result in decreased collection efficiency of the separator 210 and the filter unit 220. The heat supply means 400 serves to prevent the condensation of water.

The heat supply means 400 may be provided on a line where the condensation of water may occur. The heat supply means 400 may be provided at at least one of the sampling tube 110, the first manifold 120, the discharge tube 130, the second manifold 140 and the carbon particle collection unit 200. Specifically, it may be provided at the first manifold 120, the discharge tube 130 and the second manifold 140. More specifically, it may be provided at all the above-described components 110, 120, 130, 140, 200. In the figure, the regions where the heat supply means 400 are provided are enclosed by dotted lines.

The heat supply means 400 may be selected from, for example, a heating wire or a heating box. Also, the above-described components, for example the sampling tube 110, may be configured as a double-walled tube and the heat supply means 400 may be a thermal fluid (e.g. steam) flowing in the double-walled tube. Specifically, the heat supply means 400 may be a heating wire wound around the inner or outer wall of the above-described components. More specifically, the heat supply means 400 may comprise heating wires respectively wound around the sampling tube 110, the first manifold 120, the discharge tube 130, the second manifold 140 and the carbon particle collection unit 200.

The heat supply means 400 may be controlled by a heating controller 400C. The heating controller 400C may control the temperature of the heat supply means 400 so as to prevent the condensation of water. For example, the temperature of the heat supply means 400 may be controlled to be equal to the temperature of the samples discharged from the carbon particle emission source S. For example, the temperature of the heat supply means 400 may be controlled at about 80° C.

In accordance with the present disclosure, carbon particles of specific size may be sampled easily from a carbon particle emission source such as a charcoal kiln by inducing a smooth and stable flow of the carbon particle sample, as described above. Specifically, the carbon particle sample is smoothly supplied by the suction means 300 to the individual components and is supplied as a stable flow by the first manifold 120 and the second manifold 140. As a result, the carbon particles may be sampled easily with high efficiency. At the carbon particle collection unit 200, the carbon particles of a specific size, e.g. PM_{2.5}, are sampled easily by the multi-stage filter unit 220. Analysis data about the sampled carbon particles may be a valuable information in determining the national environmental policy.

While the exemplary embodiments have been shown and described, it will be understood by those skilled in the art that various changes in form and details may be made thereto without departing from the spirit and scope of the present disclosure as defined by the appended claims.

What is claimed is:

1. An apparatus for sampling carbon particles comprising:
a sampling tube introducing samples including carbon particles from a carbon particle emission source;
a first manifold collecting the samples introduced from the sampling tube;
a first suction means transferring the samples from the carbon particle emission source to the first manifold through the sampling tube;
a discharge tube discharging the samples from the first manifold;
a second manifold collecting the samples introduced from the discharge tube and supplying them to a carbon particle collection unit;
a second suction means transferring the samples introduced to the first manifold to the second manifold through the discharge tube;
the carbon particle collection unit receiving the samples from the second manifold and collecting the carbon particles included in the samples; and
a third suction means transferring the samples introduced to the second manifold to the carbon particle collection unit.

2. The apparatus for sampling carbon particles according to claim 1, wherein the inner diameter of the first manifold is larger than that of the sampling tube and the inner diameter of the second manifold is larger than that of the discharge tube.

3. The apparatus for sampling carbon particles according to claim 1, wherein the carbon particle collection unit comprises:
a separator separating the carbon particles from the introduced samples; and
a filter unit collecting the carbon particles separated by the separator.

4. The apparatus for sampling carbon particles according to claim 1, wherein the carbon particle collection unit comprises:
a separator separating the carbon particles from the introduced samples;
a filter unit collecting the carbon particles separated by the separator; and
a flow meter measuring the flow volume of the introduced samples.

5. The apparatus for sampling carbon particles according to claim 3, wherein the filter unit comprises:
a first filter collecting carbon particles having a particle diameter exceeding 2.5 μm; and
a second filter collecting carbon particles having a particle diameter of 2.5 μm or smaller.

6. The apparatus for sampling carbon particles according to claim 4, wherein the filter unit comprises:
a first filter collecting carbon particles having a particle diameter exceeding 2.5 μm; and
a second filter collecting carbon particles having a particle diameter of 2.5 μm or smaller.

7. The apparatus for sampling carbon particles according to claim 1, wherein a heat supply means is provided at at least one of the sampling tube, the first manifold, the discharge tube, the second manifold and the carbon particle collection unit.

8. The apparatus for sampling carbon particles according to claim 2, wherein a heat supply means is provided at at least one of the sampling tube, the first manifold, the discharge tube, the second manifold and the carbon particle collection unit.

9. The apparatus for sampling carbon particles according to claim 3, wherein a heat supply means is provided at at least one of the sampling tube, the first manifold, the discharge tube, the second manifold and the carbon particle collection unit.

10. The apparatus for sampling carbon particles according to claim 4, wherein a heat supply means is provided at at least one of the sampling tube, the first manifold, the discharge tube, the second manifold and the carbon particle collection unit.

11. The apparatus for sampling carbon particles according to claim 7, wherein the first manifold comprises a stainless steel material and the second manifold comprises a glass material.

12. The apparatus for sampling carbon particles according to claim 8, wherein the first manifold comprises a stainless steel material and the second manifold comprises a glass material.

13. The apparatus for sampling carbon particles according to claim 9, wherein the first manifold comprises a stainless steel material and the second manifold comprises a glass material.

14. The apparatus for sampling carbon particles according to claim 10, wherein the first manifold comprises a stainless steel material and the second manifold comprises a glass material.
